(19) United States
(12) Patent Application Publication
(10) Pub. No.: US 2025/0190237 A1
(43) Pub. Date: Jun. 12, 2025

(54) DEVICE ACCESS METHOD AND SYSTEM FOR SECURE DOCKER

(71) Applicant: CLOUD INTELLIGENCE ASSETS HOLDING (SINGAPORE) PRIVATE LIMITED, Singapore (SG)

(72) Inventors: Shuangtai TIAN, Hangzhou (CN); Min HE, Shanghai (CN); Xiao ZHENG, Hangzhou (CN); Xin LONG, Hangzhou (CN)

(21) Appl. No.: 18/842,327

(22) PCT Filed: Feb. 24, 2023
(86) PCT No.: PCT/CN2023/078264

§ 371 Date: Aug. 28, 2024

(30) Foreign Application Priority Data
Mar. 3, 2022 (CN) 202210210974.7

(51) Int. Cl. G06F 9/455

(52) U.S. Cl. CPC G06F 9/45558; G06F 2009/45587

(57) ABSTRACT

The present disclosure relates to a device access method and system for a secure docker. The method includes: creating a first communication module within the secure docker; creating a second communication module for communication with the first communication module in a server where the secure docker is located; creating a second device node corresponding to the secure docker in the server, and allocating at least part of hardware resources of a physical device to the second device node; creating a first device node corresponding to the at least part of the hardware resources within the secure docker; and transferring access operation information of an application program in the secure docker for the first device node to the second device node through the first communication module and the second communication module.

### CROSS-REFERENCE TO RELATED APPLICATIONS

This application is a National Stage of International Application No. PCT/CN2023/078264, and filed on Feb. 24, 2023, which claims priority to Chinese Patent Application No 202210210974.7, filed to the China National Intellectual Property Administration on Mar. 3, 2022 and entitled “DEVICE ACCESS METHOD AND SYSTEM FOR SECURE DOCKER”. The disclosures of the aforementioned applications are hereby incorporated by reference in their entireties.

### TECHNICAL FIELD

The present disclosure relates to the field of docker technologies and, in particular, to a device access method and system for a secure docker.

### BACKGROUND

A docker technology is a technique of packaging a software into a standardized unit for development, delivery, and deployment.

The docker technology can ensure consistency of application operating environment, and enable applications to start faster, with characteristics such as isolation, scalability, easy migration, and sustainable delivery and deployment.

The docker technology is widely applied in the field of cloud services based on the above characteristics.

Dockers created based on the docker technology are mainly divided into two types: a common docker and a secure docker.

The common docker is mainly based on Cgroups (control groups) and Namespace to achieve resource isolation. Different common dockers share an operating system kernel of a host machine, with weak isolation and security.

The secure docker is implemented based on a lightweight virtual machine technology. Each secure docker runs in a separate micro virtual machine with a dedicated operating system kernel, so as to avoid sharing the operating system kernel of the host machine.

The isolation and security of the secure docker are higher than those of the common docker.

Due to the isolation between the secure docker and the host machine, how to make hardware resources of the same physical device have isolation while being shared and used by multiple secure dockers, to ensure that hardware access within different secure dockers does not affect each other, is an urgent technical problem to be solved.

### SUMMARY

A technical problem to be solved by the present disclosure is to provide a solution that can ensure that the hardware resources of the same physical device have isolation while being shared and used by multiple secure dockers.

According to a first aspect of the present disclosure, a device access method for a secure docker is provided, including: creating a first communication module within the secure docker; creating a second communication module for communication with the first communication module in a server where the secure docker is located; creating a second device node corresponding to the secure docker in the server, and allocating at least part of hardware resources of a physical device to the second device node; creating a first device node corresponding to the at least part of the hardware resources within the secure docker; transferring access operation information of an application program in the secure docker for the first device node to the second device node through the first communication module and the second communication module.

In an implementation, the access operation information includes: a task instruction that needs to be executed through calling the hardware resources; and/or a data sending request that needs to be sent to the physical device.

In an implementation, the access operation information is the data sending request, and the method further includes: in response to obtaining the data sending request from the second device node, applying, by a device driver, for a memory space used for storing data, and determining a mapping relationship between a host physical address and a guest virtual address corresponding to the memory space, where the host physical address is a physical address of the memory space in the server, and the guest virtual address is a virtual address of the memory space in the secure docker; sending, by the device driver, the guest virtual address to the application program through the second communication module and the first communication module, for the application program to copy data to the guest virtual address.

In an implementation, the method further includes: obtaining, by the device driver, the data from the host physical address according to the mapping relationship, and sending the data to the physical device.

In an implementation, the step that creating the first device node within the secure docker includes: creating a device node simulation module within the secure docker, and performing, by the device node simulation module, simulation within the secure docker to obtain a virtual first device node.

In an implementation, the access operation information is a task instruction, and the step that transferring the access operation information of the application program in the secure docker for the first device node to the second device node through the first communication module and the second communication module includes: sending, by the application program in the secure docker, the task instruction through the first device node; monitoring, by the device node simulation module, the first device node to obtain the task instruction, and sending the task instruction to the second communication module through the first communication module; transferring, by the second communication module, the task instruction to the second device node corresponding to the secure docker.

In an implementation, the first device node is located in a kernel space of the secure docker, and/or the second device node is located in a kernel space of the server, and/or the first communication module is located in a user space of the secure docker, and/or the second communication module is located in a user space of the server.

According to a second aspect of the present disclosure, a device access system for a secure docker is provided, including: a client-side apparatus and a server-side apparatus, the server-side apparatus is disposed within a host machine where the secure docker is located, including a second device node corresponding to the secure docker and a second communication module used for communicating with a first communication module, where the second device node is allocated at least part of hardware resources of a physical device, the client-side apparatus is disposed within the secure docker, including the first communication module and a first device node corresponding to the at least part of the hardware resources, the client-side apparatus transfers access operation information of an application program in the secure docker for the first device node to the second device node through the first communication module and the second communication module.

In an implementation, the access operation information is the data sending request, in response to obtaining the data sending request from the second device node, a device driver applies for a memory space used for storing data and determines a mapping relationship between a host physical address and a guest virtual address corresponding to the memory space, where the host physical address is a physical address of the memory space in the host machine, and the guest virtual address is a virtual address of the memory space in the secure docker, the device driver sends the guest virtual address to the application program through the second communication module and the first communication module, for the application program to copy data to the guest virtual address.

In an implementation, the device driver obtains the data from the host physical address according to the mapping relationship, and sends the data to the physical device.

In an implementation, the first device node is located in a kernel space of the secure docker, and/or the second device node is located in a kernel space of the host machine, and/or the first communication module is located in a user space of the secure docker, and/or the second communication module is located in a user space of the host machine.

According to a third aspect of the present disclosure, a computing device is provided, including: a processor; and a memory, storing an executable code which, when executed by the processor, causes the processor to perform the method as described in the first aspect above.

According to a fourth aspect of the present disclosure, a computer program product is provided, including: an executable code which, when executed by a processor of an electronic device, causes the processor to perform the method as described in the first aspect above.

According to a fifth aspect of the present disclosure, a non-transitory machine-readable storage medium is provided, storing an executable code which, when executed by a processor of an electronic device, causes the processor to perform the method as described in the first aspect above.

Thereby, through creating the first communication module and the first device node within the secure docker, and creating, in the server where the secure docker is located, the second communication module for communication with the first communication module and the second device node corresponding to the secure docker, and transferring access operation information of an application program for the first device node to the second device node through the first communication module and the second communication module, the present disclosure enables the second device node to be used by the application program in the secure docker under the action of the first device node, the first communication module, and the second communication module. The hardware resources corresponding to the second device node are allocated to the secure docker, which enables the secure docker to call the hardware resources of the physical devices while maintaining isolation, so as to ensure that hardware access within different secure dockers does not affect each other.

### BRIEF DESCRIPTION OF DRAWINGS

The aforementioned and other purposes, features and advantages of the present disclosure will become more apparent by describing the exemplary implementations of the present disclosure in more detail in conjunction with the accompanying drawings. In the exemplary implementations of the present disclosure, the same reference numerals generally represent the same components.

FIG. 1 illustrates a schematic principle diagram of a device access method for a secure docker according to an embodiment of the present disclosure.

FIG. 2 illustrates a schematic principle diagram of a device access method for a secure docker according to another embodiment of the present disclosure.

FIG. 3 illustrates a schematic structural diagram of a device access system according to an embodiment of the present disclosure.

FIG. 4 illustrates a schematic diagram of a server instance deployed with a device access system of the present disclosure.

FIG. 5 illustrates a schematic structural diagram of a computing device according to an embodiment of the present disclosure.

### DESCRIPTION OF EMBODIMENTS

Preferable implementations of the present disclosure will be described in greater detail below with reference to the accompanying drawings. Although the preferable implementations of the present disclosure are shown in the accompanying drawings, it should be understood that the present disclosure may be implemented in various forms without being limited by implementations set forth herein. On the contrary, these implementations are provided to make the present disclosure more thorough and complete, and to fully convey the scope of the present disclosure to those skilled in the art.

A concept of a secure docker is obtained by mainly comparing with a common docker. The main difference between the secure docker and the common docker is that each secure docker (generally speaking, a docker group (pod)) runs in a separate micro virtual machine with a separate operating system kernel and security isolation at the virtualization layer. Since the instance of the cloud docker adopts a shared multi tenancy cluster, the security isolation of the docker has stricter requirements than those of a private Kubernetes (a docker cluster management system, abbreviated as “K8s”) cluster that a user independently owns. Through the secure docker, a kernel, computing resources, a storage, and a network are all isolated between dockers of different tenants, which protects resources and data of the user from being preempted and stolen by other users.

That is, the common docker runs directly in a user mode (user space, user mode space) of the host machine (such as a server) and can communicate with a kernel mode (kernel space, kernel mode space) of the host machine. While the secure docker runs in a separate micro virtual machine with an independent operating system kernel, but cannot directly communicate with the kernel mode of the host machine.

The above characteristics of the secure docker make it impossible for device nodes created on the host machine to communicate directly with the secure docker. As a result, it is impossible to create device nodes that can communicate with the secure docker directly within the host machine as for the common docker.

In view of this, according to working characteristics of the secure docker, the present disclosure proposes a device access solution (also known as a device virtualization solution) that is compatible with the secure docker, so that the secure dockers can share and use the hardware resources of the physical device while maintaining isolation, ensuring that hardware access within different secure dockers does not affect each other.

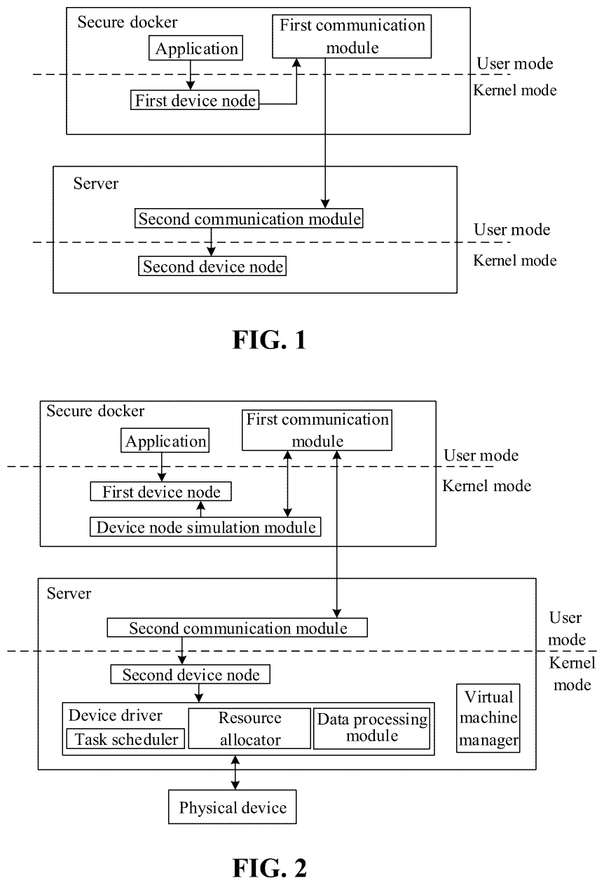

FIG. 1 illustrates a schematic principle diagram of a device access method for a secure docker according to an embodiment of the present disclosure.

Referring to FIG. 1, the present disclosure creates a communication module in the secure docker and the server where the secure docker is located (i.e., the host machine), respectively. The communication module within the secure docker can be referred to as a first communication module, and the communication module within the server can be referred to as a second communication module. The first communication module is located in the user space of the secure docker, and the second communication module is located in the user space of the server. The first communication module and the second communication module can communicate with each other. For example, network communication, such as Socket communication, can be carried out between the first communication module and the second communication module.

The present disclosure also creates a device node in the secure docker and the server where the secure docker is located, respectively. The device node within the secure docker can be referred to as a first device node, and the device node within the server can be referred to as a second device node.

The second device node is created for the secure docker. That is, each secure docker corresponds to one second device node.

At least part of hardware resources of the physical device can be allocated to the second device node. The second device node corresponds one-to-one with the secure docker. At least part of the hardware resources of the physical device are allocated to the second device node, then, the hardware resources of the physical device are allocated to the secure docker. The physical device can be a hardware device in the server, or a hardware device connected to the server and located outside the server.

The physical device can refer to a physical device, such as a cloud server host. The hardware resource can refer to a physical hardware resource, such as a CPU (central processing unit), a memory, a disk, a network, etc. For a heterogeneous computing device, the hardware resource can also include a GPU (graphics processing unit), a NPU (neural processing unit), and so on. As an example, the physical device can be the heterogeneous computing device that includes various types of computing units such as CPU, GPU, NPU, etc. The heterogeneous computing refers to a calculation method of a system composing by using computing units of system architectures and different types of instruction sets. The categories of common computing units mainly include CPU, GPU, NPU, etc.

The device node can serve as an interfaces of the device driver (kernel mode) and the application program (user mode). The application program can communicate with the device driver through the device node in a way of IOCTL (input/output control), memory mapping, direct read/write, or the like. Where the IOCTL is a system call dedicated to the device input and output operation, which passes in a request code associated with the device. The function of the system call depends entirely on the request code.

Take the operating system in the server as Linux as an example, in Linux, all devices (information about the devices) are stored in the form of files in a/dev directory, which are all accessed by means of files. The device node is an abstraction of a device by the Linux kernel, where a device node is a file. The application program accesses the device node through a standardized set of calls that are independent from any specific drive program. The drive program is responsible for mapping these standard calls to specific operations of the actual hardware.

The second device node can be a device node created by the device driver (device drive program).

The first device node can be a virtual device node obtained through simulation in the secure docker.

The second device node is located in a kernel space of the server.

The first device node is located in a kernel space of the secure docker.

The second device node can be regarded as an interface between the device driver and the application program running in the secure docker. However, the isolation of the secure docker prevents the second device node from being transferred to the secure docker for use by the application program in the secure docker. For this purpose, the first device node created within the secure docker can serve as the second device node for use by the secure docker. That is, for the application program in the secure docker, the first device node is the interface between the application program and the device driver, and the application program can communicate with the device driver through the first device node.

That is, the first device node and the second device node correspond to the same part of the hardware resources. The first device node can be used as an entry for the hardware resources allocated to the second device node within the secure docker, where the application program of the secure docker can implement access to the hardware resources through accessing the first device node.

Access operation information of the application program for the first device node can be transferred to the second device node through the first communication module and the second communication module. Therefore, under the action of the first device node, the first communication module, and the second communication module, the second device node can be used by the application program in the secure docker.

The second device node can directly communicate with the device driver, and the hardware resources corresponding to the second device node are divided for the secure docker. Therefore, the device driver can map the access operation information of the application program in the secure docker for the first device node to the actual hardware, so that the secure docker can call the hardware resources of the physical devices while maintaining isolation, so as ensure that hardware access within different secure dockers does not affect each other.

When it is necessary to allocate the hardware resources from multiple different physical devices to the same secure docker, the second device node corresponding to the secure docker can be created for each physical device, and each second device node is allocated at least part of the hardware resources of the physical device corresponding to the second device node. A plurality of first device nodes can be created in correspondence within the secure docker. The types of the access operation information of the application program in the secure docker for the first device node mainly include a task instruction that needs to be executed through calling the hardware resources of the physical device and a data sending request that needs to be sent to the physical device.

If the access operation information is the task instruction, after the task instruction of the application program in the secure docker for the first device node is transferred to the second device node via the first communication module and the second communication module, the device driver can call resources from the hardware resources allocated to the second device node to execute the task instruction according to the task instruction obtained from the second device node. The execution results of the task instruction may be transferred back to the application program through the second communication module, the first communication module, such as may be transferred back to the application program through the second device node, the second communication module, the first communication module, and the first device node.

If the access operation information is the data sending request, after the data sending request of the application program in the secure docker for the first device node is transferred to the second device node via the first communication module and the second communication module, in response to obtaining the data sending request from the second device node, the device driver can apply for a segment of memory space used for storing data and determines a mapping relationship between a host physical address (HPA) and a guest virtual address (GVA) corresponding to the memory space, and then send the guest virtual address to the application program via the second communication module and the first communication module, such as sends the guest virtual address to the application program via the second device node, the second communication module, the first communication module, and the first device node. The application program can copy the data expected to be sent to the physical device to the guest virtual address. The device driver can obtain the data from the host physical address according to the mapping relationship between the guest virtual address and the host physical address, and send the data to the physical device. Therefore, when transferring data to the physical device, instead of sending the data to the physical device via data transmission, the application only needs to copy the data to a specific segment of address to efficiently complete the delivery of data from the secure docker to the host machine without going through the data transmission step.

The host physical address is a physical address of the memory space in the server, and the guest virtual address is a virtual address of the memory space in the secure docker. The data sending request of the application program for the first device node may also be referred to as an address space application request. The request is transferred through the first communication module and the second communication module to the device driver located in the server, and when applying for the memory space, the device driver can apply for a segment of memory in the kernel layer of the server. The address of the applied memory is the host virtual address (HVA), the host physical address corresponding to the memory space can be determined according to the host virtual address of the applied memory space, that is, the HVA can be converted to HPA. When determining the mapping relationship between the HPA and the GPA, the device driver can interact with the virtual machine manager (hypervisor) that manages the secure docker to complete the mapping between the HPA and the GPA.

FIG. 2 illustrates a schematic principle diagram of a device access method for a secure docker according to another embodiment of the present disclosure.

In this embodiment, a device node simulation module can be created within the secure docker. Functions of the device node simulation module are twofold: the one is to perform simulation in the secure docker to obtain a virtual first device node; and the other one is to monitor, intercept, and forward the access operation information (tasks) of the application program in the secure docker for the first device node.

The device driver can include a task scheduler, a resource allocator, and a data processing module. The task scheduler is used to schedule the task submitted by a plurality of secure dockers through the first device node and the second device node; the resource allocator is used to allocate and isolate hardware resources from the plurality of secure dockers; and the data processing module is used for data transfer between the secure docker and the server.

The traditional device driver does not consider support for the secure docker in its design and thus suffers from various shortcomings. This solution allows the device driver to have better support for the secure docker through the following settings.
1. A plurality of device nodes

The traditional device driver typically only provides one device node as the interface between the kernel device driver and the user mode program. A plurality of user programs can communicate with the kernel device driver through the device node in way of IOCTL, memory mapping, or direct read/write, etc. However, a single device node is not suitable for isolation between a plurality of secure dockers.

Therefore, the present disclosure proposes a solution that the device driver provides a plurality of device nodes. It is also proposed to assign a plurality of device nodes to different secure dockers by way of network communication according to the characteristics of secure dockers. That is, with the help of device nodes simulated in the secure docker and communication modules disposed respectively in the secure docker and the server, the device nodes provided by the device driver are assigned to the secure dockers. The following advantages can be achieved.
1) It is easy to achieve task isolation between a plurality of device nodes. In the case of a single device node, the device driver cannot be shared and used by a plurality of secure dockers.
2) It is difficult to achieve task isolation by distinguishing which secure docker that the task comes from. While with a plurality of device nodes, the device driver can make distinctions, so that tasks sent by different secure dockers can be isolated.
3) Multiple device nodes can achieve different priorities. On the basis of task isolation, the device driver can assign different priorities to each device node, thereby achieving task priorities between different types of secure dockers.
4) Resource isolation can be achieved between a plurality of device nodes. Similar to task isolation, in the case of a plurality of device nodes, the device driver can reserve a certain amount of resources for each node, thereby avoiding the situation that other processes cannot obtain sufficient resources due to too many resources having been occupied by one process within a single device node.
5) A plurality of device nodes can be allocated resources of different sizes. With resource isolation, the resource size of each device node can be statically or dynamically allocated to different sizes, thereby allowing different dockers to obtain different resource sizes.
6) The number of a plurality of device nodes does not need to be fixed and can be dynamically allocated, which can support flexible docker quantities.
2. Task scheduler

In a traditional task manager, there is usually no task scheduler, or the implementation of the task scheduler is very simple.

In the present disclosure, the task scheduler can schedule tasks submitted from different device nodes based on a time slice, a physical execution unit, or other methods (such as a priority) to ensure that: tasks of device nodes with the same priority occupy the same time slice or physical execution unit; and the task of the device node with a high priority occupies more time slices or physical execution units than those occupied by the task of the device node with a low priority.
3. Resource manager

To prevent a secure docker from occupying too many resources, a resource manager can be used to isolate resources to ensure that: a certain secure docker cannot access resources within other secure dockers; each secure docker cannot use resources beyond its limit. Similarly, similar to the task scheduler, the resource manager can set different resource limits for different dockers and achieve better hardware resource utilization through different resource allocation strategies.
4. Data processing module

The data processing module is responsible for establishing a channel for data transmission between the secure docker and the host machine device.
5. The implementation of the device node of the secure docker is based on the kernel (the kernel of the operating system, often used to refer in particular to the kernel of the Linux operating system) layer. The application software is not perceptive and does not require any modifications.
6. Working in a standard secure docker.

When the application program in the secure docker (e.g., TensorFlow) is using devices (e.g., a GPU and a NPU device) and submitting a task to the devices, there are mainly two interaction paths: control flow and data flow. The control flow refers to a task instruction sent to the physical device, and the data flow refers to data submitted to the physical device.

The present disclosure can achieve device virtualization isolation from two aspects: the control flow and the data flow.
1. Control flow

The application program in the secure docker can send the task instruction through the first device node. After monitoring the task instruction, the device node simulation module can intercept the task instruction and send the task instruction to the second communication module through the first communication module. The second communication module can transfer the task instruction to the second device node corresponding to the secure docker. After obtaining the task instruction from the second device node, the device driver can call the hardware resources allocated for the secure docker to execute the task instruction under the action of the task scheduler.

For example, in the secure docker, the main function is to forward the call of the IOCTL from the user layer to the kernel layer. The application sends the call of the IOCTL to the device node simulation module through the first device node; after intercepting this operation, the device node simulation module transfers the call of the IOCTL to the corresponding second device node in the host machine through the first communication module and the second communication module.
2. Data flow

In the secure docker, the application (such as TensorFlow) transfers data to the device, usually through a method (memory mapping) that the device driver applies for a memory space for data transfer, and then copies the data to the corresponding address space.

In the present disclosure, the application can apply for a segment of address space through the device node simulation module. The device node simulation module in the secure docker can transfer this task to the data processing module in the host machine. The data processing module first applies for a segment of memory (HVA) at the kernel layer of the host machine, and then converts it to the physical address HPA of the host machine. The data processing module can correspond, through interacting with the hypervisor that manages the secure docker, the physical address HPA of the host machine with the virtual address (Guest Virtual Address, GVA) in the docker to obtain the mapping relationship between the two. The GVA is returned to the data processing module, and the data processing module can return the GVA to the application layer of the secure docker through the second communication module and the first communication module, so that the application can copy data to this segment of address, and the data processing module can find the corresponding HVA to obtain the data, whereby the delivery of data from the secure docker to the host machine can be efficiently accomplished without the need for data transmission.

The present disclosure has at least the following advantages compared to existing solutions.
1) The technical solution of the present disclosure is mainly in the kernel driver and does not involve an interface to a user mode API. When there is a change to the user API interface, the present disclosure does not require any modifications, thus ensuring that users is not perceive and avoiding potential risks and losses during the upgrade and maintenance process.
2) Through forwarding calls to the IOCTL class of nodes, the present disclosure achieves resource isolation and sharing of the device, achieves a virtualization solution for the secure dockers to share the device, and completes address mapping between the secure docker GVA and the host machine HVA through managing the hypervisor of the secure docker, and by avoiding data copying and handling, performance can be improved.
3) In the present disclosure, as the physical addresses of various device node resources are within the same physical address range, there is no need for additional address conversion or additional page table structures, and therefore there will be no performance loss.
4) The present disclosure has high maintainability, high performance, and high flexibility, which makes it more suitable for a heterogeneous computing application in the future docker than other different solutions, and should have a place in future heterogeneous computing cloud services.

The present disclosure creates the device node for the secure docker through modifying the device driver, and through simulating the device node within the secure docker, achieves communication between the device node created by the device driver and an application within the secure docker with the aid of a network communication method based on the simulated device node, thereby achieving the purpose of resource isolation, and the present disclosure can be used in the secure docker.

Unlike existing device virtualization solutions in the secure docker, the present disclosure proposes a lightweight device virtualization solution that directly implements a plurality of device nodes in the device driver of the kernel, and links them to device nodes inside the secure docker through a network, so as to enable a physical device to be shared by a plurality of secure docker instances while ensuring the requirement of resource isolation and task isolation between secure dockers.

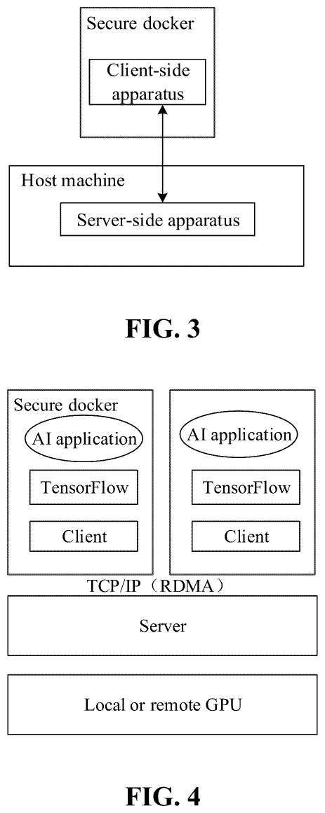

FIG. 3 illustrates a schematic structural diagram of a device access system according to an embodiment of the present disclosure.

As shown in FIG. 3, the device access system includes a client-side apparatus and a server-side apparatus. The client-side apparatus is disposed within a secure docker. The server-side apparatus is disposed within a host machine (e.g., a server) where the secure docker is located.

The server-side apparatus includes a second device node corresponding to the secure docker and a second communication module used for communicating with the first communication module, where the second device node is allocated at least part of hardware resources of a physical device.

The client-side apparatus includes the first communication module and a first device node corresponding to the at least part of the hardware resources.

The client-side apparatus can transfer access operation information of an application program in the secure docker for the first device node to the second device node through the first communication module and the second communication module.

The client-side apparatus can also include a device node simulation module. The server-side apparatus can also include a data processing module, a task scheduler, a resource allocator, and the like. Regarding the device node simulation module, the data processing module, the task scheduler, and the resource allocator, please refer to the relevant descriptions herein above, which will not be repeated here.

FIG. 4 illustrates a schematic diagram of a server instance deployed with a device access system of the present disclosure.

As shown in FIG. 4, a plurality of secure dockers can be created in a server (such as a cloud server). An AI (Artificial Intelligence) application such as TensorFlow can be run in each secure docker. A client-side apparatus (Client) is deployed in the secure docker, and a server-side apparatus (Server) is deployed in the host machine where the secure docker is located. The communication between the client-side apparatus and the server-side apparatus can be based on a TCP/IP protocol, and also supports a RDMA (remote direct memory access, direct data access) function. Under the action of the Client and the Server, a local or remote GPU can be shared by a plurality of secure docker instances while ensuring the requirements of resource isolation and task isolation between secure dockers.

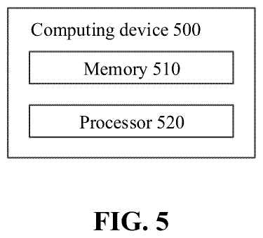

FIG. 5 illustrates a schematic structural diagram of a computing device that can be used to implement the above device access method for a secure docker according to an embodiment of the present disclosure.

Referring to FIG. 5, the computing device 500 includes a memory 510 and a processor 520.

The processor 520 may be a multi-core processor or may contain a plurality of processors. In some embodiments, the processor 520 may include a general-purpose main processor as well as one or more special co-processors, such as a graphics processing unit (GPU), a digital signal processor (DSP), and the like. In some embodiments, the processor 520 may be implemented using a custom circuitry, such as an application specific integrated circuit (ASIC) or a field programmable gate array (FPGA).

The memory 510 may include various types of storage units, such as a system memory, a read-only memory (ROM), and a permanent storage apparatus. Where the ROM may store static data or instructions needed by the processor 520 or other modules of a computer. The permanent storage apparatus may be a read-write storage apparatus. The permanent storage apparatus may be a non-volatile storage device that does not lose stored instructions and data even after the computer power outage. In some implementations, the permanent storage apparatus employs a mass storage apparatus (e.g., a magnetic or optical disc, a flash memory) as the permanent storage apparatus. In some other implementations, the permanent storage apparatus may be a removable storage device (e.g., a floppy disk, an optical drive). The system memory can be a read-write storage device or a volatile read-write storage device, such as a dynamic random access memory. The system memory can store some or all of the instructions and data that the processor needs to run. In addition, the memory 510 can include any combination of computer-readable storage media, including various types of semiconductor storage chips (a DRAM, a SRAM, a SDRAM, a flash memory, a programmable read-only memory), as well as a magnetic disc and/or an optical disc. In some embodiments, the memory 510 may include a removable storage devices that are readable and/or writable, such as a laser disc (CD), a read-only digital multifunctional disc (such as a DVD-ROM, a double-layer DVD-ROM), a read-only Blu-ray disc, an ultra-density disc, a flash card (such as a SD card, a min SD card, a Micro-SD card, etc.), a magnetic floppy disk, and the like. The computer readable storage media do not contain carrier waves and instantaneous electronic signals transmitted in a wireless or wired way.

The memory 510 stores an executable code, which, when executed by the processor 520, can enable the processor 520 to execute the device access method described above.

The device access method and system for a secure docker, and the computing device according to the present disclosure have been described in detail with reference to the accompanying drawings herein above.

In addition, according to the method of the present disclosure, it can also be implemented as a computer program or a computer program product, which includes computer program code instructions for executing the above various steps defined in the above method of the present disclosure.

Alternatively, the present disclosure may be implemented as a non-transitory machine-readable storage medium (or a computer-readable storage medium, or a machine-readable storage medium), on which an executable code (or a computer program, or a computer instruction code) is stored when the executable code (or the computer program, or the computer instruction code) is executed by a processor of an electronic device (or a computing device, a server, etc.), the processor is enabled to execute the various steps of the above method according to the present disclosure.

Those skilled in the art will also understand that various exemplary logical blocks, modules, circuits, and algorithm steps described in conjunction with the disclosure here can be implemented as electronic hardware, computer software, or a combination of both.

The flowcharts and the block diagrams in the accompanying drawings show the possible architecture, functions, and operations of the system and the method according to multiple embodiments of the present disclosure. At this point, each block in the flowcharts or the block diagrams can represent a module, a segment of program, or part of codes, which contains one or more executable instructions used for implementing a specified logical function. It should also be noted that, in some alternative implementations, the functions marked in the block can also occur in a different order from those marked in the accompanying drawings. For example, two consecutive blocks can actually be executed in basic parallel, and sometimes they can also be executed in an opposite order, depending on the function involved. It should also be noted that each block in the block diagrams and/or the flowcharts, as well as the combinations of blocks in the block diagrams and/or the flowcharts, can be implemented using dedicated hardware based systems that perform specified functions or operations, or can be implemented using a combination of dedicated hardware and computer instructions.

The above has described various embodiments of the present disclosure, and the above description is exemplary, not exhaustive, and is not limited to the disclosed embodiments. Without deviating from the scope and spirit of the described embodiments, many modifications and changes are obvious to persons of ordinary skill in the art. The selection of terms used herein aims to best explain the principles, practical applications, or improvements to technologies in the market of each embodiment, or to enable other persons of ordinary skill in the art to understand the disclosed embodiments herein.

1. A device access method for a secure docker, comprising:
creating a first communication module within the secure docker;
creating a second communication module for communication with the first communication module in a server where the secure docker is located;
creating a second device node corresponding to the secure docker in the server, and allocating at least part of hardware resources of a physical device to the second device node;
creating a first device node corresponding to the at least part of the hardware resources within the secure docker;
transferring access operation information of an application program in the secure docker for the first device node to the second device node through the first communication module and the second communication module.

2. The method according to claim 1, wherein the access operation information comprises: a task instruction that needs to be executed through calling the hardware resources; and/or a data sending request that needs to be sent to the physical device.

3. The method according to claim 2, wherein the access operation information is the data sending request, and the method further comprises:
in response to obtaining the data sending request from the second device node, applying, by a device driver, for a memory space used for storing data, and determining a mapping relationship between a host physical address and a guest virtual address corresponding to the memory space, wherein the host physical address is a physical address of the memory space in the server, and the guest virtual address is a virtual address of the memory space in the secure docker;
sending, by the device driver, the guest virtual address to the application program through the second communication module and the first communication module, for the application program to copy data to the guest virtual address.

4. The method according to claim 3, further comprising:
obtaining, by the device driver, the data from the host physical address according to the mapping relationship, and sending the data to the physical device.

5. The method according to claim 1, wherein the creating the first device node within the secure docker comprises:
creating a device node simulation module within the secure docker, and performing, by the device node simulation module, simulation within the secure docker to obtain a virtual first device node.

6. The method according to claim 5, wherein the access operation information is a task instruction, and the transferring the access operation information of the application program in the secure docker for the first device node to the second device node through the first communication module and the second communication module comprises:
sending, by the application program in the secure docker, the task instruction through the first device node;
monitoring, by the device node simulation module, the first device node to obtain the task instruction, and sending the task instruction to the second communication module through the first communication module;
transferring, by the second communication module, the task instruction to the second device node corresponding to the secure docker.

7. The method according to claim 1, wherein,
the first device node is located in a kernel space of the secure docker, and/or
the second device node is located in a kernel space of the server, and/or
the first communication module is located in a user space of the secure docker, and/or
the second communication module is located in a user space of the server.

8. A device access system for a secure docker, comprising: a client-side apparatus and a server-side apparatus,
the server-side apparatus is disposed within a host machine where the secure docker is located, comprising a second device node corresponding to the secure docker and a second communication module used for communicating with a first communication module, wherein the second device node is allocated at least part of hardware resources of a physical device,
the client-side apparatus is disposed within the secure docker, comprising the first communication module and a first device node corresponding to the at least part of the hardware resources,
the client-side apparatus transfers access operation information of an application program in the secure docker for the first device node to the second device node through the first communication module and the second communication module.

9. The system according to claim 8, wherein,
the access operation information is a data sending request, in response to obtaining the data sending request from the second device node, a device driver applies for a memory space used for storing data and determines a mapping relationship between a host physical address and a guest virtual address corresponding to the memory space, wherein the host physical address is a physical address of the memory space in the host machine, and the guest virtual address is a virtual address of the memory space in the secure docker,
the device driver sends the guest virtual address to the application program through the second communication module and the first communication module, for the application program to copy data to the guest virtual address.

10. The system according to claim 9, wherein the device driver obtains the data from the host physical address according to the mapping relationship, and sends the data to the physical device.

11. The system according to claim 8, wherein,
the first device node is located in a kernel space of the secure docker, and/or
the second device node is located in a kernel space of the host machine, and/or
the first communication module is located in a user space of the secure docker, and/or
the second communication module is located in a user space of the host machine.

12. A computing device, comprising:
a processor; and
a memory, storing an executable code which, when executed by the processor, causes the processor to:
create a first communication module within the secure docker;
create a second communication module for communication with the first communication module in a server where the secure docker is located;
create a second device node corresponding to the secure docker in the server, and allocate at least part of hardware resources of a physical device to the second device node;
create a first device node corresponding to the at least part of the hardware resources within the secure docker;
transfer access operation information of an application program in the secure docker for the first device node to the second device node through the first communication module and the second communication module.

13. (canceled)

14. A non-transitory machine-readable storage medium, storing an executable code which, when executed by a processor of an electronic device, causes the processor to perform the method according to claim 1.

15. The device according to claim 12, wherein the access operation information comprises: a task instruction that needs to be executed through calling the hardware resources; and/or a data sending request that needs to be sent to the physical device.

16. The device according to claim 15, wherein the access operation information is the data sending request, and the processor is further caused to:
in response to obtaining the data sending request from the second device node, apply, through a device driver, for a memory space used for storing data, and determine a mapping relationship between a host physical address and a guest virtual address corresponding to the memory space, wherein the host physical address is a physical address of the memory space in the server, and the guest virtual address is a virtual address of the memory space in the secure docker;
send, through the device driver, the guest virtual address to the application program via the second communication module and the first communication module, for the application program to copy data to the guest virtual address.

17. The device according to claim 16, wherein the processor is further caused to:
obtain, through the device driver, the data from the host physical address according to the mapping relationship, and send the data to the physical device.

18. The device according to claim 12, wherein the processor is further caused to:
create a device node simulation module within the secure docker, and perform, through the device node simulation module, simulation within the secure docker to obtain a virtual first device node.

19. The device according to claim 18, wherein the access operation information is a task instruction, and the processor is further caused to:
send, through the application program in the secure docker, the task instruction via the first device node;
monitor, through the device node simulation module, the first device node to obtain the task instruction, and send the task instruction to the second communication module via the first communication module;
transfer, through the second communication module, the task instruction to the second device node corresponding to the secure docker.

20. The device according to claim 18, wherein,
the first device node is located in a kernel space of the secure docker, and/or
the second device node is located in a kernel space of the server, and/or
the first communication module is located in a user space of the secure docker, and/or
the second communication module is located in a user space of the server.
